(19) United States
(12) Patent Application Publication
(10) Pub. No.: US 2020/0343851 A1
(43) Pub. Date: Oct. 29, 2020

(54) CONSTRUCTION BLOCK WITH PHOTOVOLTAIC DEVICE

(71) Applicant: University of Exeter, Exeter, Devon (GB)

(72) Inventors: Hasan Baig, Penryn, Cornwall (GB); Tapas Mallick, Penryn, Cornwall (GB); James Morgan Williams, Penryn, Cornwall (GB)

(21) Appl. No.: 16/604,823

(22) PCT Filed: Apr. 4, 2018
(86) PCT No.: PCT/GB2018/050905

§ 371 Date: Oct. 11, 2019

(30) Foreign Application Priority Data
Apr. 11, 2017 (GB) 1705840.5

(51) Int. Cl. H02S 20/26; E04C 1/42; H02S 40/22

(52) U.S. Cl. CPC H02S 20/26; H02S 40/22; E04C 1/42

(57) ABSTRACT

A construction block (10) is described, comprising an input wall (16) and an output wall (22) spaced apart from the input wall (16), a void (32) being formed between the input wall (16) and the output wall (22), wherein the input wall (16) has a plurality of projections (18) formed integrally therewith, the projections (18) extending toward but stopping short of the output wall (22) and serving to disrupt convection currents forming in the void (32), at least one of the projections (18) comprising a solar concentrator which has a photovoltaic device (28) mounted thereon.

This invention relates to a construction block for use in a building, the block preferably being of transparent, light transmissive form, and which includes a photovoltaic device to permit the generation of electricity.

The use of transparent, typically glass, blocks in buildings to form internal partitions whilst allowing light to pass through the partitions, or in the formation of sections of external walls which allow the transmission of light therethrough is well known. Such blocks are sometimes of solid glass form, but other arrangements in which the blocks are of hollow form are also known, such arrangements being advantageous in that they are of reduced weight and material cost.

The incorporation of photovoltaic cells into or onto building structures to allow the generation of electricity is also well known. By way of example, large photovoltaic panels are often located upon or incorporated into the roofs of buildings or are mounted upon the external walls of buildings.

Arrangements are known in which photovoltaic panels or cells are incorporated into glass blocks, alongside rechargeable batteries or the like and electrically operable light emitting devices such as light emitting diodes to form a solar powered light which may be incorporated into a structure, for example in the walls or floors thereof. However, in arrangements of this type, the panels or cells and other components substantially prevent the passage or transmission of light completely through the block, and so such devices are unsuitable for use in the formation of light transmitting wall or floor sections.

Large solar cells are usually of opaque form and so incorporation of such panels or cells into a transparent block would prevent the block from allowing the transmission of light from one surface thereof to another. Clearly, therefore, the incorporation of large solar cells into transparent blocks intended for use in the construction of a light transmitting region or section of a wall, floor or partition is not appropriate.

Arrangements are known in which solar collector devices are used to allow smaller dimension photovoltaic devices to be used and so allowing a quantity of light to pass completely through the block. Such arrangements allow the generation of electricity whilst being suitable for use in the construction of a light transmissive partition.

Where used in part of an exterior wall of a building, it is desirable for a transparent block to not only allow the transmission of light between opposing surfaces thereof in order to achieved the desired function of admitting light to the building, but also for the block to be of good thermal insulating properties so as to avoid significantly negatively impacting upon the overall thermal insulating properties of the building in which they are used. Known arrangements are of relatively poor thermal insulating properties and so are unsuitable for use in such applications.

It is an object of the invention to provide a block suitable for use in such applications and in which at least some of the disadvantages associated with known blocks are overcome or are of reduced effect.

According to the present invention there is provided a block comprising an input wall and an output wall spaced apart from the input wall, a void being formed between the input wall and the output wall, wherein the input wall has a plurality of projections formed integrally therewith, the projections extending toward the output wall and serving to disrupt convection currents forming in the void, at least one of the projections comprising a solar concentrator which has a photovoltaic device mounted thereon.

The projections preferably stop short of the output wall, but arrangements are possible in which they extend substantially to the position of the output wall, being spaced therefrom only by a sufficient distance to permit the mounting of the photovoltaic device thereon. By stopping short of the output wall, conduction of thermal energy across the block between the input wall and the output wall is avoided or restricted.

It will be appreciated that in such an arrangement, as the photovoltaic device is mounted upon a solar concentrator, it need not be of large dimensions. Consequently, a significant quantity of light is able to pass the photovoltaic device, passing from the input wall to the output wall, and so the block is suitable for use in applications in which it is desired to allow light to enter a building, whilst still allowing electrical energy to be generated. By providing projections which disrupt the formation of convection currents in the void, the thermal insulating properties of the block are enhanced.

The projections preferably extend to positions spaced from the input wall by at least 25% of the spacing between the input wall and the output wall. Preferably, they extend to positions spaced from the input wall by 30-60% of the said spacing. Such an arrangement is advantageous in that the formation of convection currents is significantly disrupted, in use, by the projections. As mentioned above, conduction of heat energy between the input and output walls is avoided or restricted.

At least one of the input wall and the output wall preferably has a peripheral wall formed integrally therewith, the peripheral wall extending towards the other of the input wall and the output wall. Preferably, peripheral walls are associated with both the input wall and the output walls, the peripheral walls engaging one another to space the input wall and the output wall apart from one another, the input wall, the output wall and the peripheral walls together defining the void. The peripheral walls may be cold fused to one another. However, if desired, other securing techniques may be used.

The projections may be arranged in a regular array. However, other patterns may be used, if desired.

When viewed from the input wall, the parts of the block formed with the solar concentrator(s) and photovoltaic device(s) will appear as dark spots or regions. By appropriate positioning of the projections, a desired visual appearance may be achieved. For example, the dark spots may be arranged to give the appearance of dark lines. If desired, certain of the projections may have no photovoltaic device associated therewith. Instead, they may have a coloured element associated therewith, with the result that the block appears to have coloured spots or regions thereon or therein. Again, by appropriate location of the projections, a desired visual appearance may be achieved.

The outer face of the input wall may be shaped to include domed regions aligned with the projections. The domed regions may serve to increase the angle of incidence with which light is able to enter the projections.

The output wall may be patterned to provide a desired visual effect. By way of example, it may be textured to provide an obscure glazed effect. Alternatively, through the use of coloured elements mounted upon the projections the block may give the effect of a series of coloured spots or pixels.

Where a plurality of photovoltaic devices is present, they are conveniently connected together, and output conductors from the devices are preferably arranged to pass from the block, for example through an opening formed in the output wall or between the input and output walls.

The projections may take a range of forms. Where serving as solar concentrators, they are preferably shaped in such a manner as to define an input side of, for example, substantially circular or elliptical shape and an output side of, for example, substantially square or rectangular shape. Whilst the aforementioned shapes are convenient, other shapes may be used. By way of example, the input and/or output sides may be of polygonal shape such as being of hexagonal shape, or they may be of non-regular shape. The photovoltaic device is preferably of substantially the same dimensions as the output side. The input sides of adjacent ones of the solar concentrators are preferably spaced apart from one another.

Between the input and output sides of the solar concentrators, the projections are preferably shaped to define side walls of curved form. For example, they may be of a hyperbolic curved form. The curved form of the side walls is advantageous in that the solar concentrators allow light from a wide range of angles of incidence upon the input side to be transmitted to the output side. By way of example, the range of angles of incidence may be as large as approximately 150°. In contrast, where flat sided projections are used, the range of angles of incidence may be as low as 2°.

The invention will further be described, by way of example, with reference to the accompanying drawings, in which:

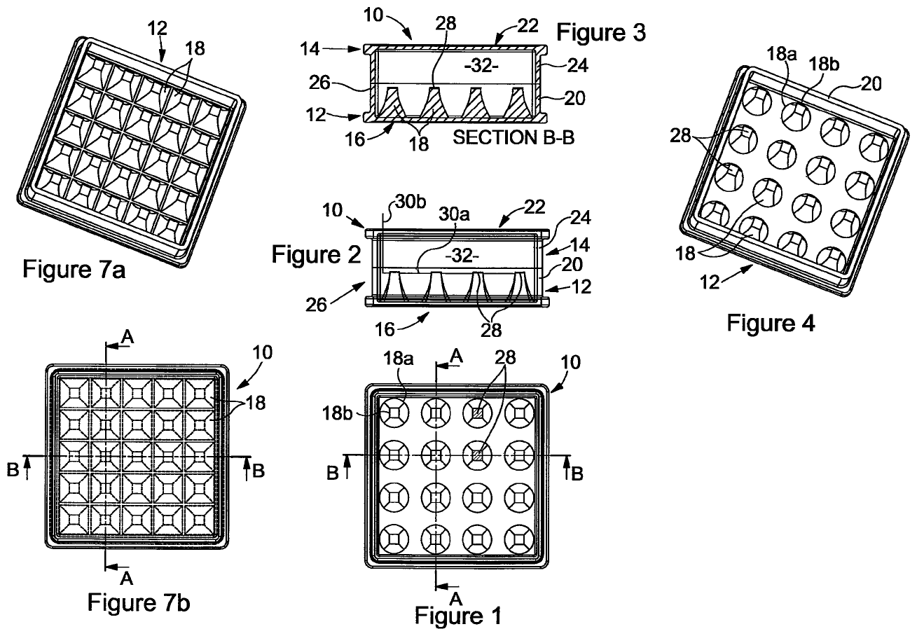

FIG. 1 is a front view of a construction block in accordance with an embodiment of the invention;

FIG. 2 is a side view of the block of FIG. 1;

FIG. 3 is a cross-sectional view through the block of FIG. 1;

FIG. 4 is a perspective view illustrating part of the block of FIG. 1;

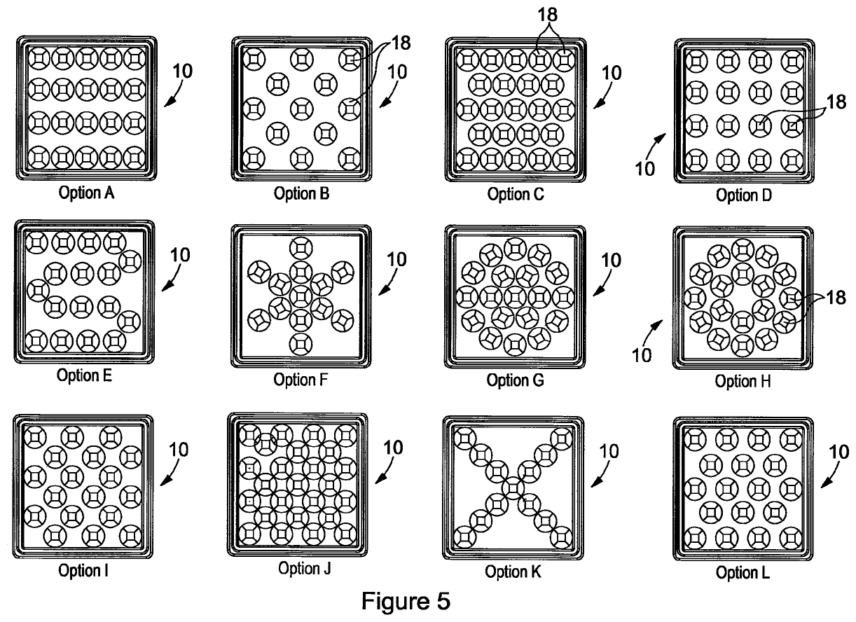

FIG. 5 is a series of views illustrating example projection layouts;

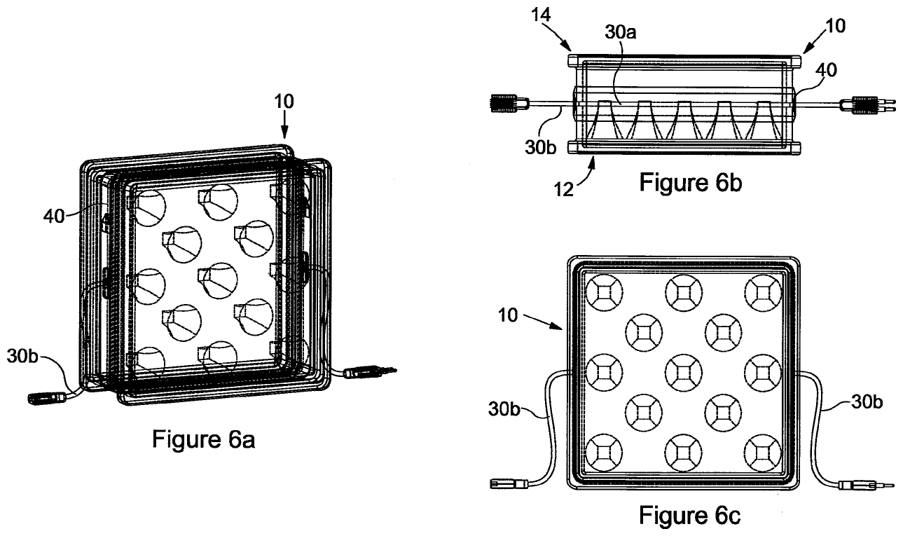

FIGS. 6a to 6c are views illustrating a modified embodiment of the invention; and

FIGS. 7a and 7b illustrate another embodiment.

Referring firstly to FIGS. 1 to 4 of the accompanying drawings, a construction block 10 is illustrated, the block 10 being of substantially transparent form, being largely manufactured of a transparent glass material. The block 10 is intended for use in the formation of light transmitting sections of walls in buildings. These sections may take the form of internal partitions or floors, or parts thereof, but the block is especially suitable for use in external walls, being of good thermal insulating properties as described herein. The block 10 is not intended to bear significant loads, in use, and so typically a lintel or the like will be located above the section to support higher parts of the building.

The block 10 comprises a front section 12 and a rear section 14, both of which are of moulded glass form. The front section 12 is shaped to define an input wall 16 which, in use, faces towards the exterior of the building. Formed integrally with the input wall 16 are a series of projections 18. Around the periphery of the input wall 16 is integrally formed a peripheral wall 20. As shown in FIGS. 2 and 3, the peripheral wall 20 is of slightly greater height than the projections 18 in this embodiment.

In the arrangement shown, the outer surface of the input wall 16 is of slightly dished form so that a central part thereof is spaced inwardly compared to peripheral parts thereof.

The rear section 14 comprises an output wall 22 and an integral peripheral wall 24. The rear section 14 is thus of similar form to the front section 12 with the exception that the rear section 14 does not include the projections 18.

As illustrated, the input and output walls 16, 22 are of substantially square form, the corners thereof being slightly rounded. However, the invention is not restricted in this regard and a range of other shapes are possible. By way of example, blocks 10 of rectangular form are possible without departing from the scope of the invention. Similarly, the blocks 10 could be of hexagonal or triangular form, such shapes being advantageous in that they tessellate. However, the invention is not restricted in this regard, and the blocks could be of other shapes such as of circular cross sectional shape.

As shown in FIGS. 2 and 3, the peripheral walls 20, 24 are spaced inwardly from the edges of the input and output walls 16, 22 such that in the finished product a shallow channel 26 extends around the block 10. Depending upon the construction technique used in the formation of the light transmitting wall section, this channel may contain, in use, an adhesive material used to secure or bond the blocks 10 in position, and/or it may contain parts of a mounting frame or the like. The manner in which the blocks 10 are fixed in position, in use, is not of relevance to the present invention and so will not be described in further detail herein.

In the arrangement illustrated, each of the projections 18 takes the form of a solar concentrator, each projection 18 being shaped to include an input side 18a of substantially elliptical or circular form (circular in the arrangement shown in FIGS. 1 to 4) and an output side 18b of square or rectangular form (square in the arrangement shown in FIGS. 1 to 4), and side walls of curved, hyperbolic form extending between the input side 18a and the output side 18b. The shape of the projections 18 is such that light incident upon the input side 18a undertakes multiple internal reflections and is concentrated upon the output side 18b. The shape allows light from a wide range of angles of incidence, for example in the region of 150°, to pass from the input side 18a to the output side 18b. This is advantageous as sunlight will be able to pass to the output side 18b for the majority of daylight hours. The precise shape of the solar concentrator may depend upon the position and orientation in which the block is to be mounted to maximise the incidence of light at the output side 18b. Whilst specific shapes for the projection 18 are illustrated, it will be appreciated that the invention is not restricted in this regard. The side walls could be of, for example, parabolic form or of linear form, the input sides may be of, for example, circular form (as shown in FIG. 5), or of polygonal form, for example, and the output side may be of square shape (as shown in FIG. 5) or of a range of other shapes. FIGS. 7a and 7b illustrate an arrangement in which the input sides 18a are of square shape. In the arrangement of FIGS. 7a and 7b, the projections 18 are relatively closely packed, only small spaces being present therebetween. However, it will be appreciated that they may be spaced further apart, if desired, and may be arranged to form a desired pattern in a manner similar to those shown in FIG. 5.

The projections 18 are shaped such that the areas of the output sides 18b, together, make up considerably less than 10% of the area of the output wall 22. Consequently, from the output wall side of the block 10, the block 10 will have a bright, light appearance when light is incident upon the input wall thereof.

Mounted upon the output side 18b of each projection is a respective photovoltaic device 28. The devices 28 may take a range of forms, but are conveniently of silicon solar cell technology having a performance in the region of 20-25%. Such materials are relatively low in cost. Conveniently, the devices 28 are permanently mounted in position upon the output sides 18b of the projections 18, for example by means of an appropriate adhesive. The devices 28 are arranged such that the light incident thereon causes the generation of an electrical output, and conductors 30a are provided which interconnect the devices 28, conductors 30b being provided by which the electrical output can be supplied, via an opening formed in the output wall 22 to the exterior of the block 10, from where it may be supplied to a remote location, if desired.

With the devices 28 and conductors 30a, 30b correctly mounted in position, the front and rear sections 12, 14 are secured to one another with the free edges of the peripheral wall 20 of the front section 10 abutting the free edges of the peripheral wall 24 of the rear section 14. In this position, the free edges are cold fused to one another, or are otherwise secured to one another to form the finished block.

As illustrated, the projections 18 extend to a location spaced from the input wall 16 by a spacing that is greater than 25% of the distance between the input wall 16 and the output wall 22. Indeed, the spacing preferably falls in the range 30 to 60% of the said distance, and in the arrangement shown is approximately 45% of the distance. By arranging for the projections 18 to project from the input wall 16 by a significant distance, it will be appreciated that the formation of convection currents in the air (or other gas) located in the void 32 defined between the front and rear sections 12, 14 is disrupted. By disrupting the formation of convection currents, thermal energy losses between the output wall 22 and the input wall 16 are reduced, and so the thermal insulating properties of the block 10 are enhanced. However, by ensuring that the projections 18 stop significantly short of the output wall 22, conduction of thermal energy between the input and output walls 16, 22 is restricted or avoided. Again, therefore, the thermal insulating properties of the block 10 are enhanced as a result.

In use, where a light transmitting wall section is constructed using blocks 10 of the form described hereinbefore, some of the light incident on the input wall 16 will be transmitted between the input wall 16 and the output wall 22, with the result that light is able to enter the building through the light transmitting wall section. Additionally, some of the light incident upon the input wall 16, in the region of the input sides 18a of the projections 18, will be incident upon the photovoltaic devices 28 with the result that an electrical output is generated, to be output from the block 10 via the conductors 30.

The block 10 thus serves to allow light to enter the building whilst also serving to generate electricity. As described above, the presence of the projections 18 extending from the input wall 16 within the void 32 serves to disrupt the formation of convection currents in the air within the void 32, and so enhances the thermal insulating properties of the block 10.

When viewed from the input wall side of the block 10, the presence of the devices 28, which are typically of dark coloured form, viewed through the projections 18 results in the block 10 appearing to have a series of dark spots or regions thereon, each of the input sides 18a appearing as a dark spot or region. As, in the arrangement illustrated, the projections 18 are arranged as a regular array, the dark spots or regions appear as a regular array on or in the block 10. If desired, the projections may be arranged to achieve a desired pattern or visual appearance, for example to form lines or other patterns. FIG. 5 is a series of views illustrating a number of other possible layouts. It will be appreciated that these are merely examples, and that the invention also encompasses a number of other layouts.

Whilst in the arrangement illustrated each projection 18 has a device 28 mounted thereon, if desired one or more of the projections could instead have a coloured material element mounted thereon so that, when viewed from the input wall side, the block 10 would appear to have one or more coloured spots or regions thereon or therein. The colours may be chosen depending upon the intended use of the block, and the positions of the projections 18, and hence of the spots or regions, may be selected, as mentioned above, to achieve a desired visual impression.

Similarly, when viewed from the output wall 22, the presence of the devices 28 and/or coloured elements may result in the block 10 having a patterned visual appearance, and by appropriate positioning of the projections 18, devices 28 and coloured elements, a desired visual appearance may be achieved. If desired, the output wall 22 may be textured to provide an obscure glazed or misted appearance, for example, and/or may be of coloured or tinted form.

In the arrangement shown, the input wall 16 adjacent input sides 18a is substantially planar. To increase the angles of incidence by which light may enter the projections 18, domed regions may be incorporated into the input wall 16, aligned with each input side 18a.

FIGS. 6a to 6c illustrate an alternative design. In the arrangement of FIGS. 6a to 6c, rather than directly fuse the sections 12, 14 to one another, an intermediate frame member 40 is located therebetween through which the output conductor 30b extends.

As shown, the conductors 30b are provided with connectors to allow a series of the blocks 10 to be electrically connected to one another

It will be appreciated that whilst specific arrangements are described herein, a number of modifications and alterations may be made to the block without departing from the scope of the invention as defined by the appended claims.

1. A block comprising an input wall and an output wall spaced apart from the input wall, a void being formed between the input wall and the output wall, wherein the input wall has a plurality of projections formed integrally therewith, the projections extending toward the output wall and serving to disrupt convection currents forming in the void, at least one of the projections comprising a solar concentrator which has a photovoltaic device mounted thereon.

2. A block according to claim 1, wherein the projections extend substantially to the output wall, at least one of the projections being spaced therefrom slightly to accommodate the photovoltaic device.

3. A block according to claim 1, wherein the projections stop short of the output wall.

4. A block according to claim 3, wherein the projections extend to positions spaced from the input wall by at least 25% of the spacing between the input wall and the output wall.

5. A block according to claim 4, wherein the projections extend to positions spaced from the input wall by 30-60% of the said spacing.

6. A block according to claim 1, where at least one of the input wall and the output wall has a peripheral wall formed integrally therewith, the peripheral wall extending towards the other of the input wall and the output wall.

7. A block according to claim 6, wherein peripheral walls are associated with both the input wall and the output walls, the peripheral walls engaging one another to space the input wall and the output wall apart from one another, the input wall, the output wall and the peripheral walls together defining the void.

8. A block according to claim 7, wherein the peripheral walls are cold fused to one another.

9. A block according to claim 1, wherein the projections are arranged in a regular array.

10. A block according to claim 1, wherein the projections are arranged to provide a predetermined visual appearance to the block when viewed from the input wall side thereof.

11. A block according to claim 1, wherein at least one of the projections has a coloured element provided thereon.

12. A block according to claim 1, wherein the outer face of the input wall is shaped to include domed regions aligned with the projections.

13. A block according to claim 1, wherein at least one of the projections is shaped in such a manner as to define an input side of substantially circular or elliptical, square or rectangular shape and an output side of substantially square or rectangular shape.

14. A block according to claim 13, wherein the photovoltaic device is of substantially the same dimensions as the output side.

15. A block according to, wherein the input sides of adjacent ones of the solar concentrators are spaced apart from one another.

16. A block according to claim 13, wherein each projection includes a side wall extending between the input side and the output side, the side wall being of curved profile.

17. A block according to claim 1, wherein the input wall and the output wall are of square, rectangular, hexagonal or triangular shape.
